(19) United States
(12) Patent Application Publication
(10) Pub. No.: US 2025/0351981 A1
(43) Pub. Date: Nov. 20, 2025

(54) Wall Hanger

(71) Applicant: Michael Anthony Martinez, San Francisco, CA (US)

(72) Inventor: Michael Anthony Martinez, San Francisco, CA (US)

(21) Appl. No.: 19/082,120

(22) Filed: Mar. 17, 2025

Related U.S. Application Data
(60) Provisional application No. 63/649,424, filed on May 19, 2024.

(51) Int. Cl. A47G 1/20; F16B 45/02

(52) U.S. Cl. CPC A47G 1/20; F16B 45/024

(57) ABSTRACT

A wall hanger, comprising: a base portion adapted to mounting to a wall, comprising a hanger rod channel and a hanger rod removably positionable therein, and a first tongue monolithically extending therefrom; a hanger portion pivotably mountable on the hanger rod in the base portion, a hanger portion distal end comprising an outwardly facing first hook portion for receiving an article for hanging, a hanger portion proximal end comprising a second hook portion for hanging on the hanger rod, the second hook portion comprising a second tongue monolithically extending therefrom, the hanger portion further comprising a hanger portion body with a pair of lateral slots for receiving an elastic band; and the elastic band, for looping through the hanger portion pair of lateral slots and around the base portion first tongue.

### CROSS-REFERENCE TO RELATED APPLICATIONS

This application claims benefit of 63/649,424, filed May 19, 2024.

### STATEMENTS REGARDING FEDERALLY SPONSORED RESEARCH AND DEVELOPMENT Not applicable.

### BACKGROUND

The embodiments of the present invention satisfy the needs of having a better wall hanger.

Information relevant to attempts to address these problems can be found in U.S. Pat. Nos. 9,483,084; 9,464,469; 8,113,476; 8,011,633; 6,152,157; 5,406,678; 4,976,486; 4,019,345; 3,020,013; 2,252,196; 1,752,312; 1,514,111; 673,000; which are not admitted to be prior art with respect to the present invention by their mention in this Background Section. It is desirable to have better apparatuses and/or methods than what is disclosed in the identified references.

U.S. Pat. No. 8,113,476 claims a hinged picture hanger. The piece is relatively complicated to manufacture and assemble. The base portion that attaches to the wall is not planar but j-shaped such that the curved end of the base portion cradles the picture wire. The pivotable portion is situated at the distal end of the curved end of the j-shaped base portion, where it acts as a conduit to guide the frame wire into the hook of the wall hanger. The pivotable portion is not the cradle of the picture hanger. The hinge has no intermediate positions. US '476 cannot be used on hardware that lack open tops, such as swivel clips or alligator clips; because in those cases the pivotable portion cannot pass through the clip and the hanger acts more like an unstable cantilever than a robust secure support.

Hanging an item on a wall often presents unique challenges. If the item is large enough and flat, it can be difficult to place a hook on a hanger. Hanging a framed picture on a wall hanger can be especially difficult. Framed pictures are generally opaque. The picture frame hanging wire is often pulled taut and it lies close to the back of the picture frame. The wall hanger is often small and often lies flush to the wall. These circumstances can conspire to make it difficult to snag the frame wire on the wall hanger. It can also be difficult to ascertain whether the picture was hanging on the wire or whether the wall hanger had snagged a frame border instead.

### SUMMARY

The embodiments of the present invention comprise a wall hanger, comprising: a base portion adapted for mounting to a wall, comprising a hanger rod and a first tongue; a hanger portion pivotably mountable on the hanger rod in the base portion, comprising a second tongue; and an elastic band for looping around the first tongue and the second tongue; wherein the elastic band is looped around the tongues such that the elastic band holds the hanger portion in an upwardly pivoted position; and wherein the first tongue counters an upward pivot into the upwardly pivoted position by acting as a stop for the second tongue.

Optionally, there is a first cutout in a bottom of the base portion, the first cutout creating a fork of two lateral arms monolithically extending from the base portion; a hanger rod channel for receiving the hanger rod, the hanger rod channel having a longitudinal axis that passes through the first cutout and through each of the two lateral arms, the hanger rod channel for receiving the hanger rod such that the first longitudinal axis is coextensive with the hanger rod; wherein the first tongue is suspended in the first cutout between the two lateral arms.

Optionally, there is at least one base portion channel in the base portion for receiving a means for fastening the base portion to a wall.

Optionally, the hanger portion comprises a hanger portion proximal end and a hanger portion distal end, the hanger portion proximal end comprising the hanger rod hook for mounting on the hanger rod, and the hanger portion distal end comprising at least one upwardly opening hanger hook adapted for receiving an article for hanging.

Optionally, the means for fastening the base portion to a wall comprises a nail.

Optionally, the hanger portion distal end comprises two upwardly opening hanger hooks, such that the hanger portion is y-shaped.

Optionally, a longitudinal axis of the at least one channel for receiving a means for fastening passes along the base portion plane of symmetry.

Optionally, the first tongue comprises at least one hook for securing the elastic band.

Optionally, a front elevation view of the base portion comprises a shape of an equilateral triangle with a truncated apex.

Optionally, a front elevation view of the base portion comprises a shape of a circle, a peripheral edge of the base portion comprising a removable clamp having two clamp arms, and wherein the hanger rod channel passes through the two clamp arms.

Optionally, an interior surface of the removable clamp has at least one key and an exterior edge of the base portion has at least one corresponding key seat, such that together they form a keyed connection.

Optionally, the means for fastening the base portion to the wall comprises a screw.

### SOME ADVANTAGES OF THE EMBODIMENTS OF THE INVENTION

The embodiments of the present invention greatly simplify the process of hanging something on a wall, especially a picture. They make the hook easier to position, and they make it easier to snag the picture frame hardware.

The embodiments of the present invention are relatively simple to manufacture and assemble.

These and other advantages will become apparent as the embodiments of the invention are used.

### DESCRIPTIONS OF THE DRAWINGS

These and other features, aspects and advantages of the embodiments of the device and/or methods will become better understood with reference to the following description, appended claim and accompanying drawings where:

FIG. 1 shows a front elevation view of a first embodiment of the invention with a single hanger hook;

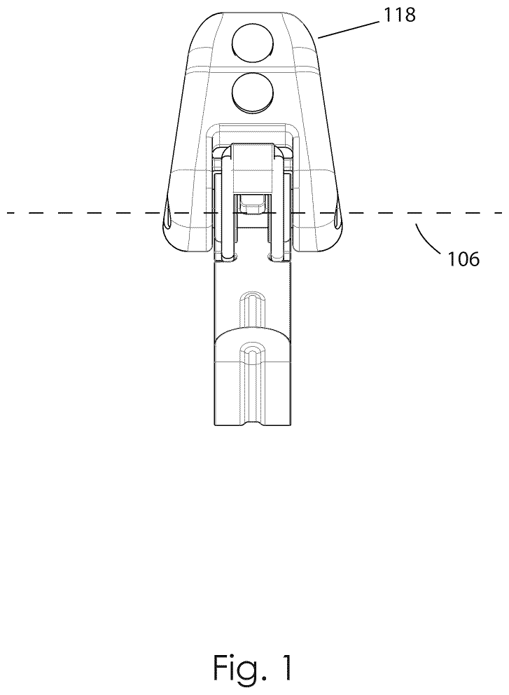

FIG. 2 shows a rear elevation view of the first embodiment of the invention;

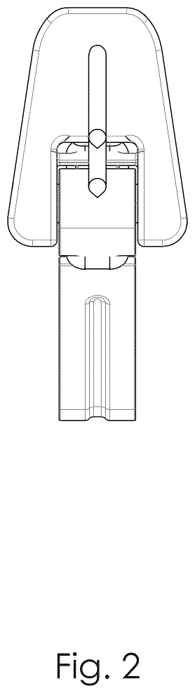

FIG. 3 shows a right elevation view of the first embodiment of the invention;

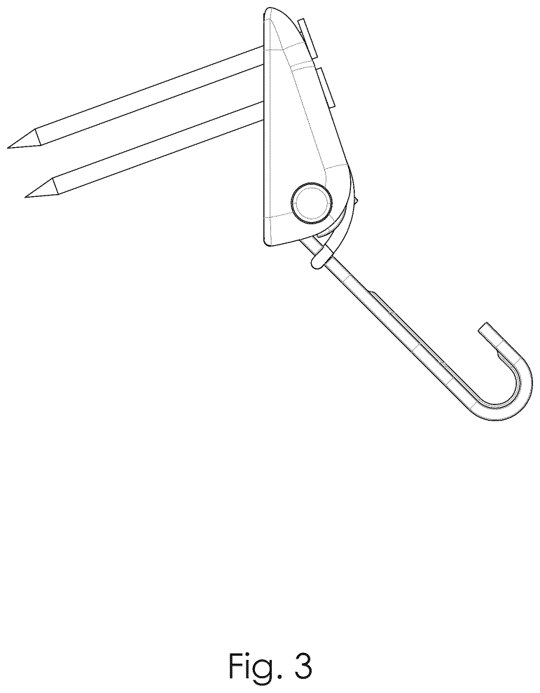

FIG. 4 shows a left elevation view of the first embodiment of the invention;

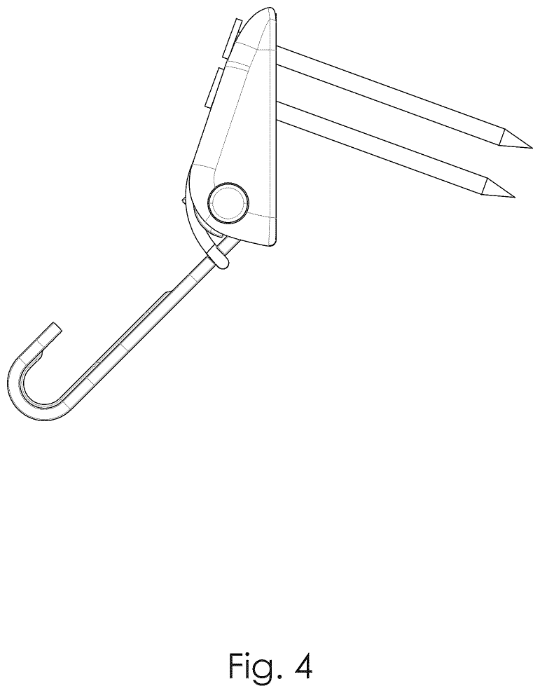

FIG. 5 shows a top plan view of the first embodiment of the invention;

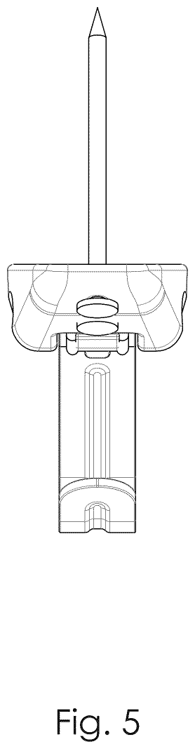

FIG. 6 shows a bottom plan view of the first embodiment of the invention;

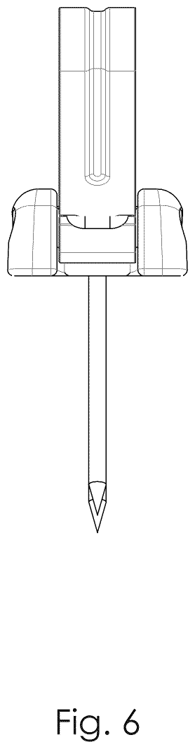

FIG. 7 shows a perspective view of the first embodiment of the invention;

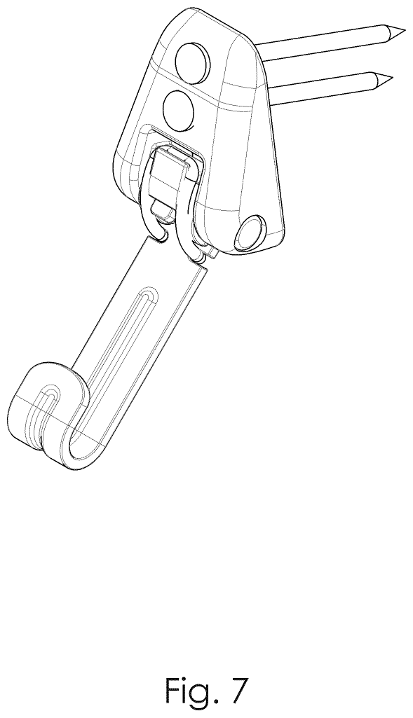

FIG. 8 shows a perspective exploded view of the first embodiment of the invention;

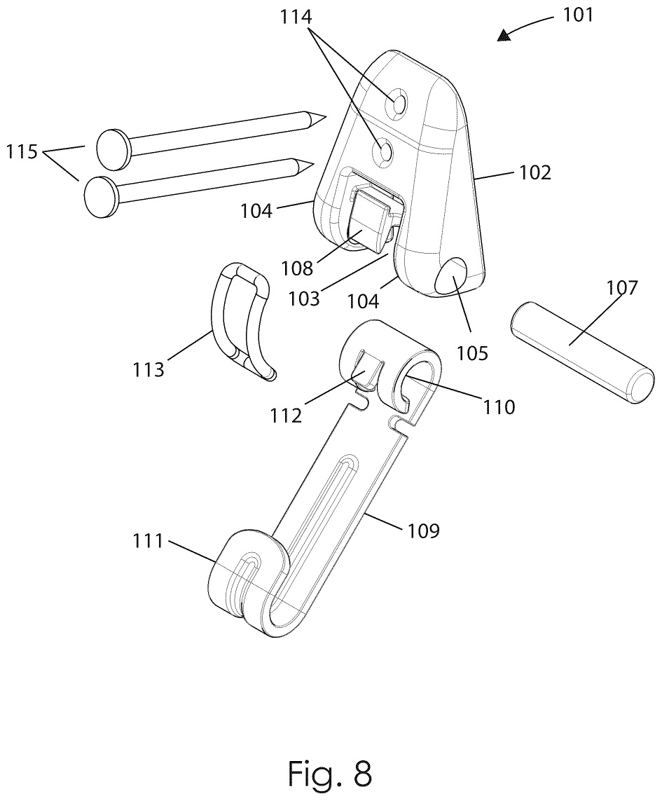

FIG. 9 shows a front elevation exploded view of the first embodiment of the invention;

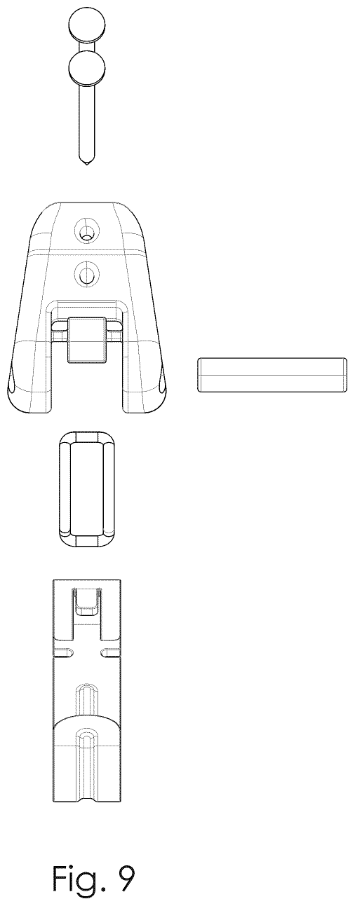

FIG. 10 shows a rear elevation exploded view of the first embodiment of the invention;

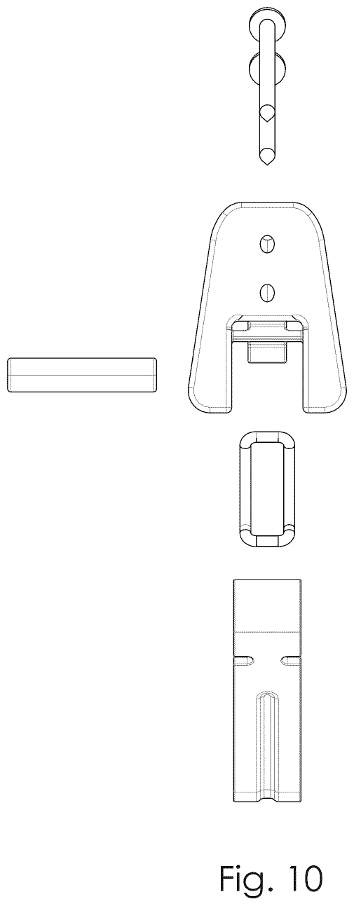

FIG. 11 shows a front elevation view of a second embodiment of the invention with two hanger hooks;

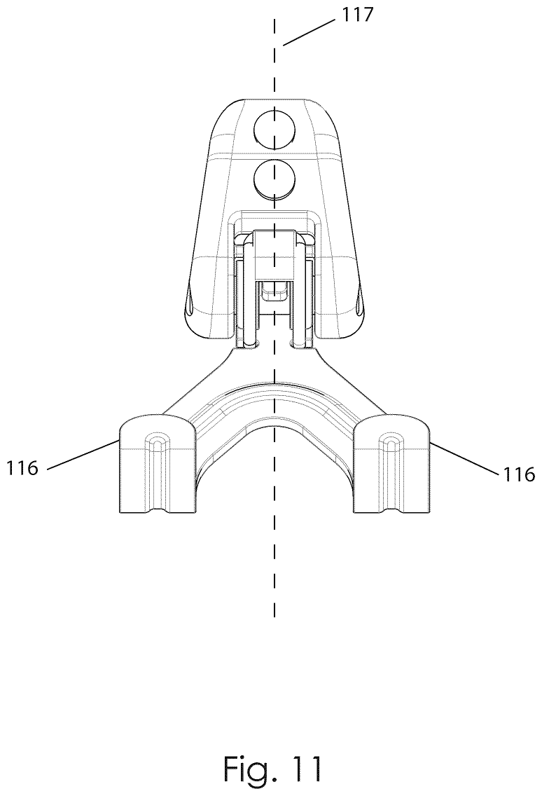

FIG. 12 shows a rear elevation view of the second embodiment of the invention;

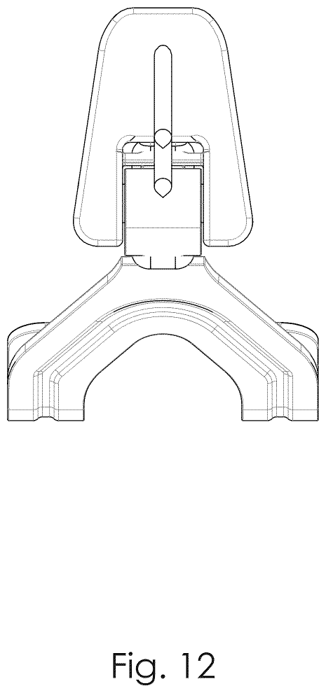

FIG. 13 shows a right elevation view of the second embodiment of the invention;

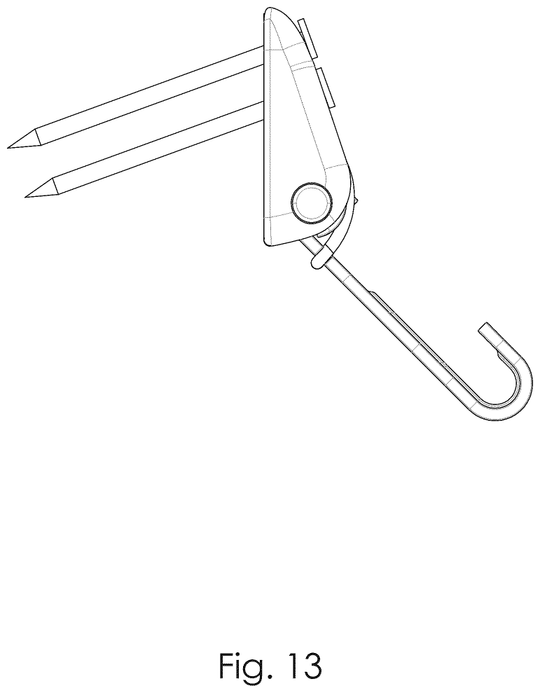

FIG. 14 shows a left elevation view of the second embodiment of the invention;

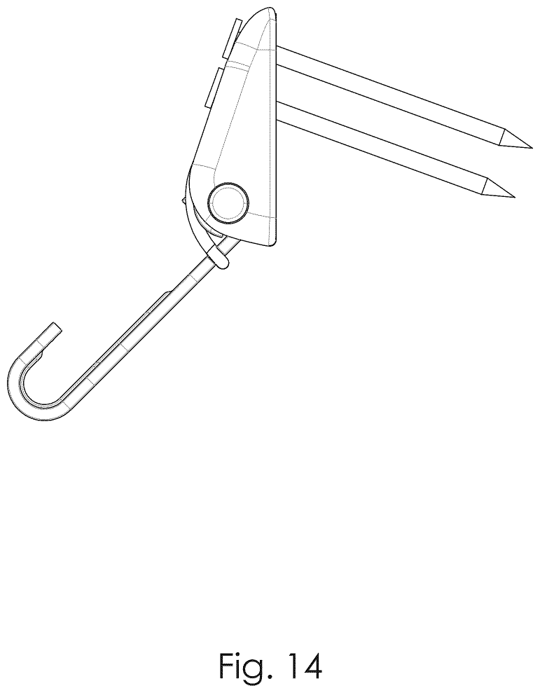

FIG. 15 shows a top plan view of the second embodiment of the invention;

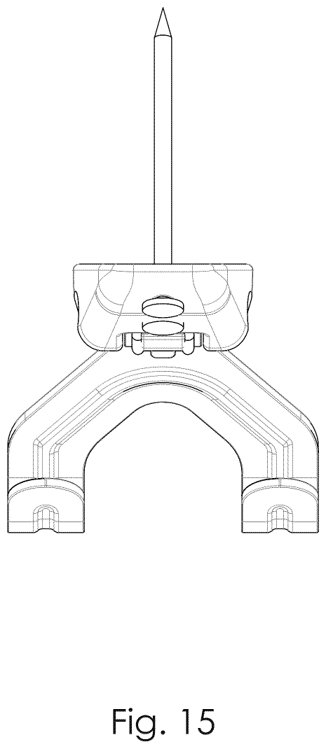

FIG. 16 shows a bottom plan view of the second embodiment of the invention;

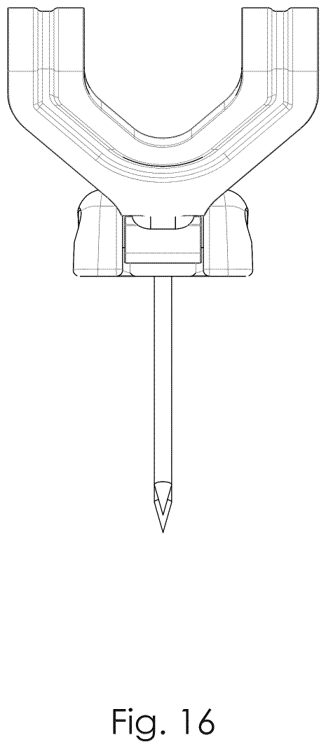

FIG. 17 shows a perspective view of the second embodiment of the invention;

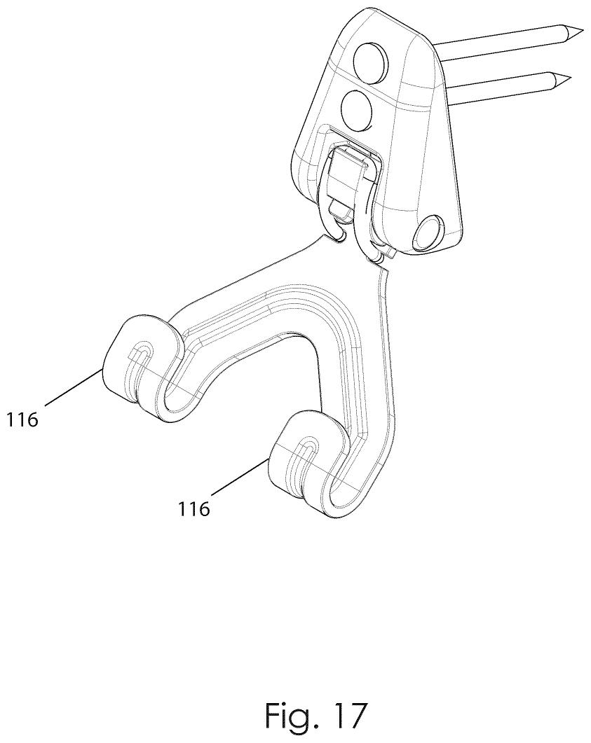

FIG. 18 shows a perspective exploded view of the second embodiment of the invention;

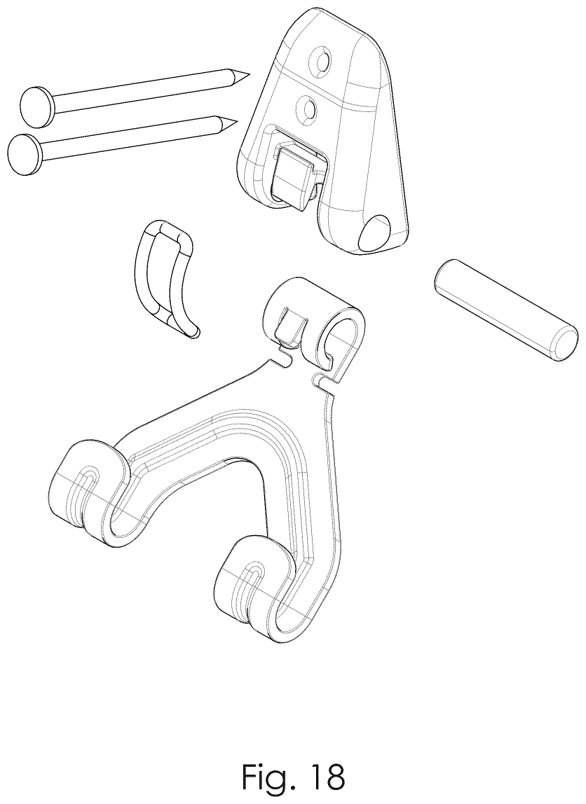

FIG. 19 shows a front elevation exploded view of the second embodiment of the invention;

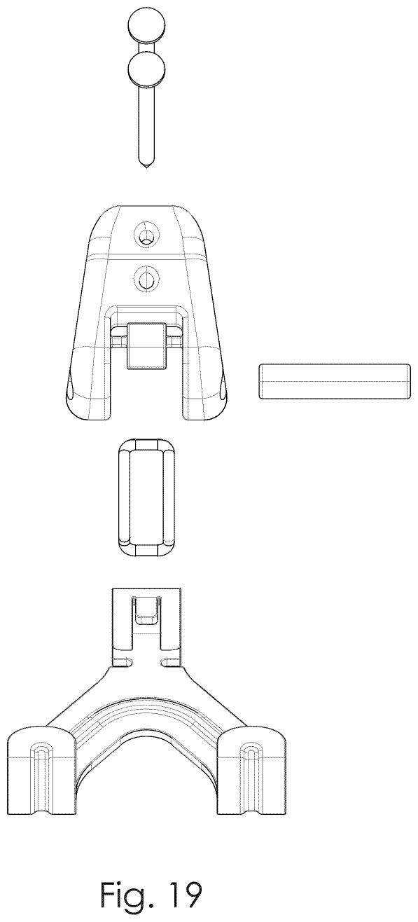

FIG. 20 shows a rear elevation exploded view of the second embodiment of the invention;

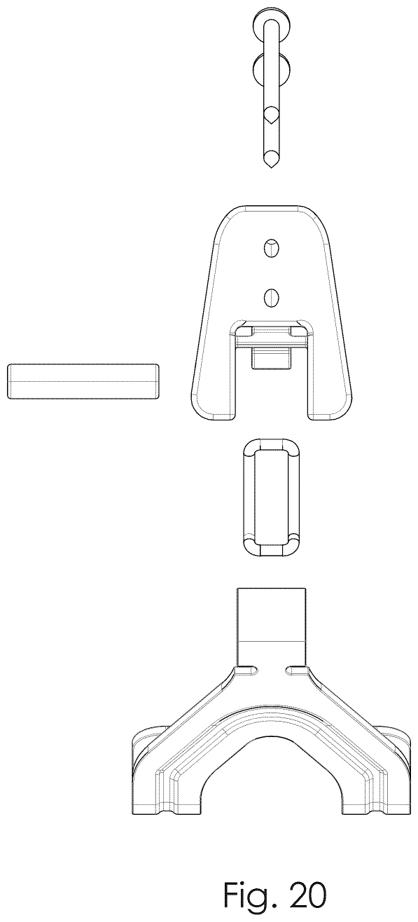

FIG. 21 shows a front elevation view of a third embodiment of the invention wherein a front elevation view of the base portion comprises a shape of a circle and there is one hanger hook;

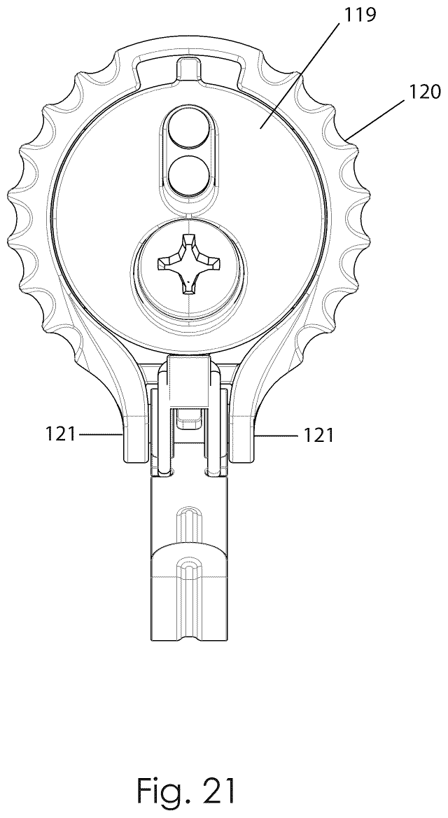

FIG. 22 shows a rear elevation view of the third embodiment of the invention;

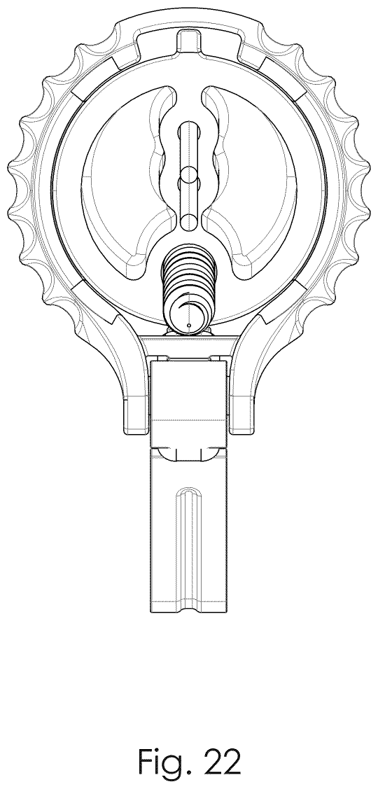

FIG. 23 shows a right elevation view of the third embodiment of the invention;

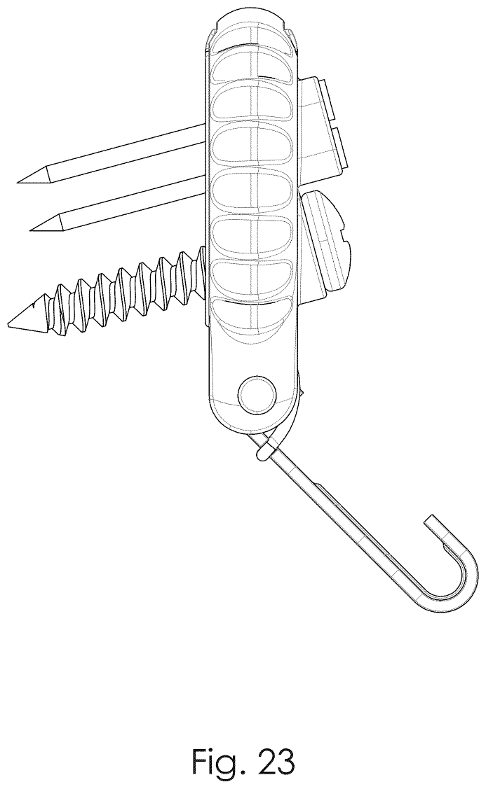

FIG. 24 shows a left elevation view of the third embodiment of the invention;

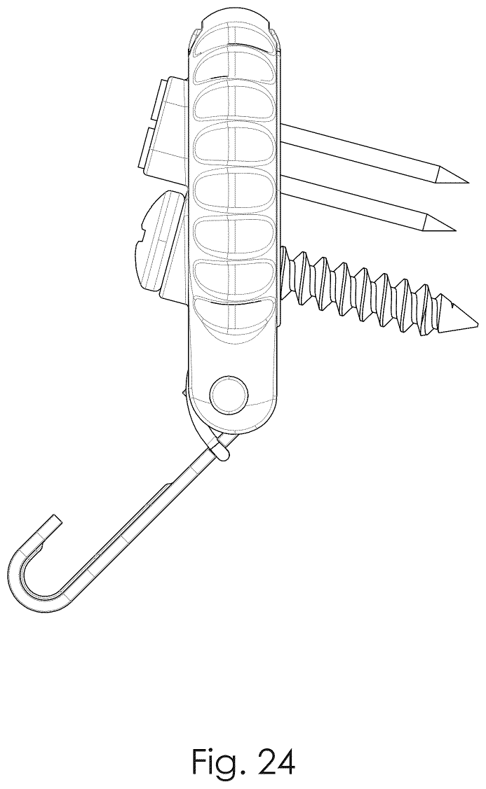

FIG. 25 shows a top plan view of the third embodiment of the invention;

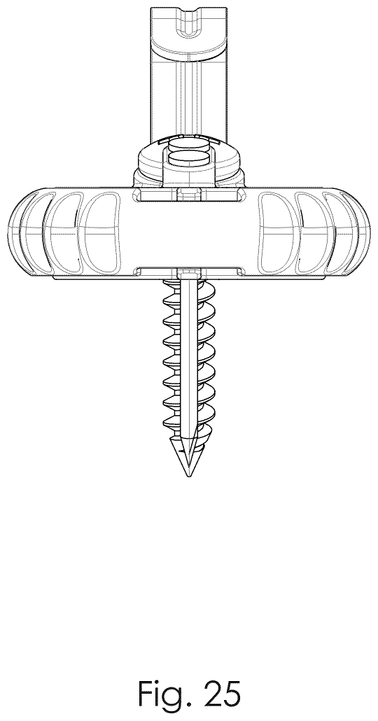

FIG. 26 shows a bottom plan view of the third embodiment of the invention;

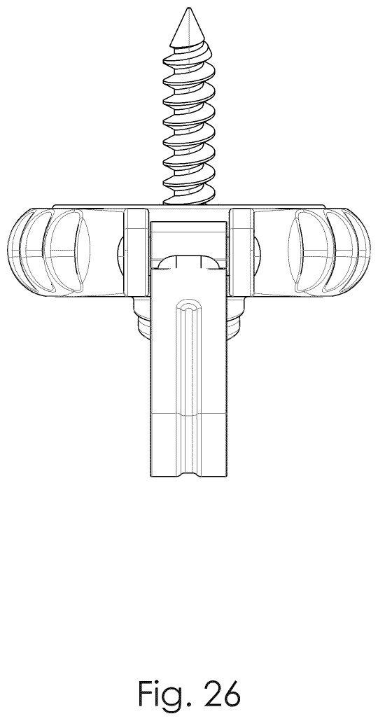

FIG. 27 shows a perspective view of the third embodiment of the invention;

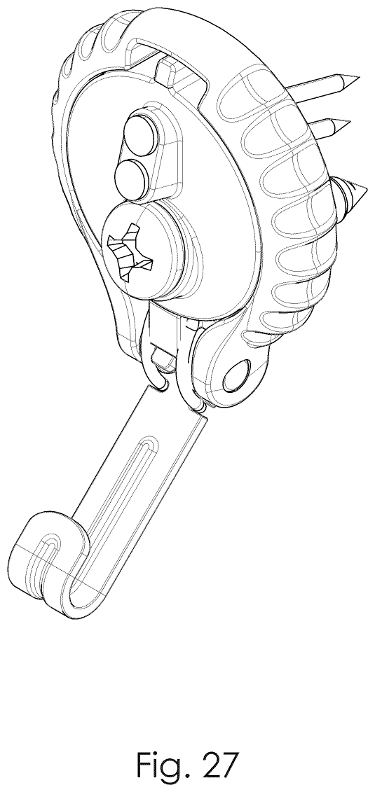

FIG. 28 shows a perspective exploded view of the third embodiment of the invention;

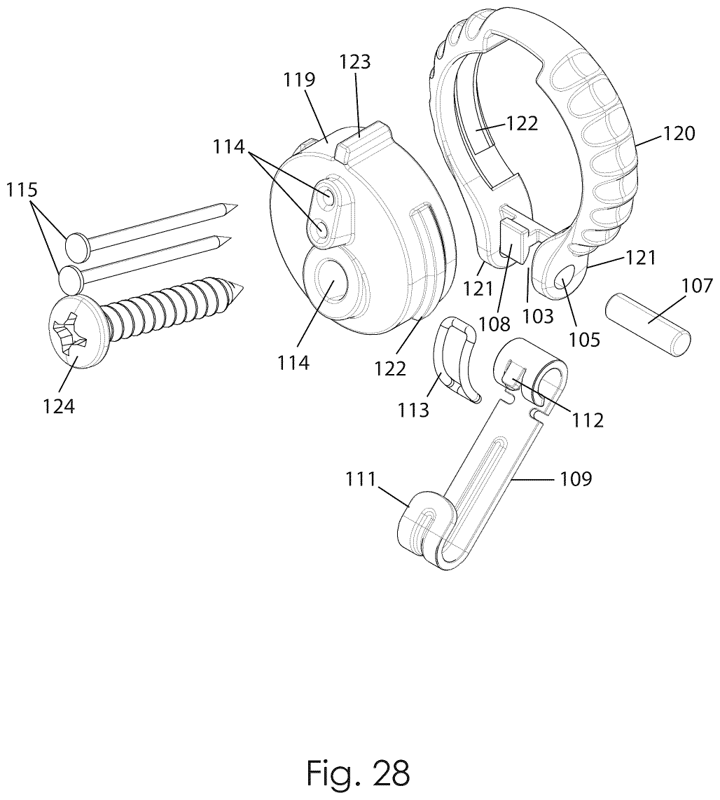

FIG. 29 shows a front elevation view of a fourth embodiment of the invention wherein a front elevation view of the base portion comprises a shape of a circle and there are two hanger hooks;

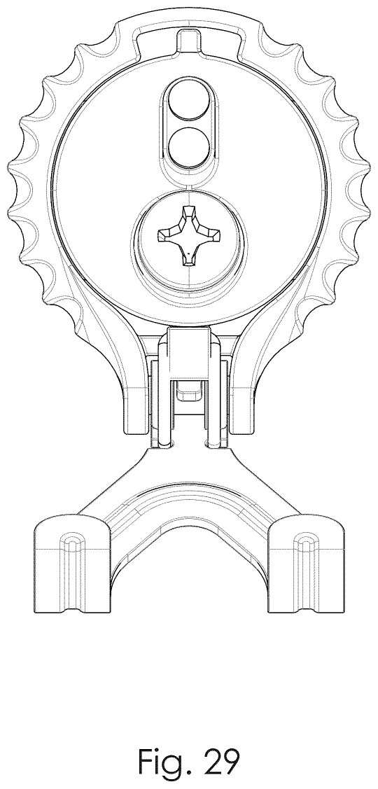

FIG. 30 shows a rear elevation view of the fourth embodiment of the invention;

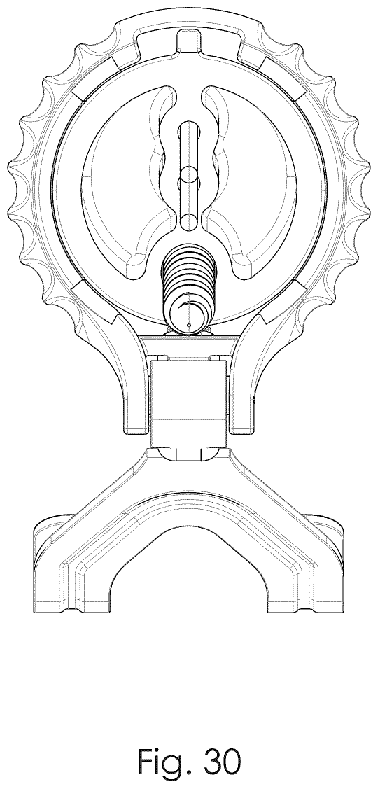

FIG. 31 shows a right elevation view of the fourth embodiment of the invention;

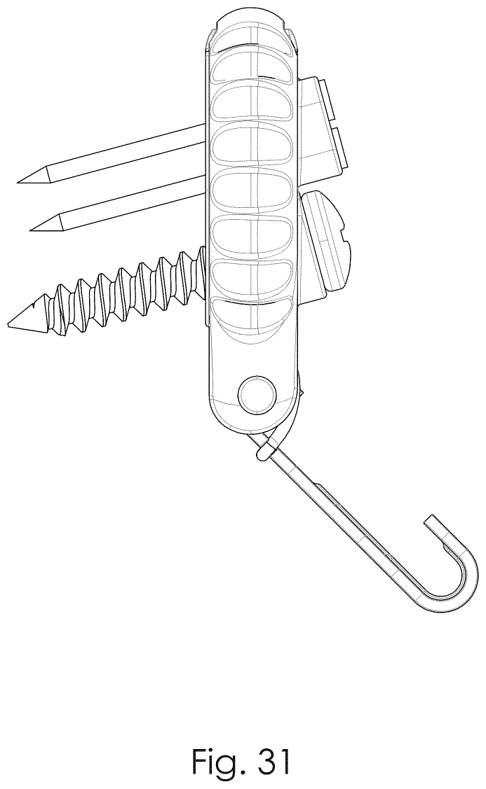

FIG. 32 shows a left elevation view of the fourth embodiment of the invention;

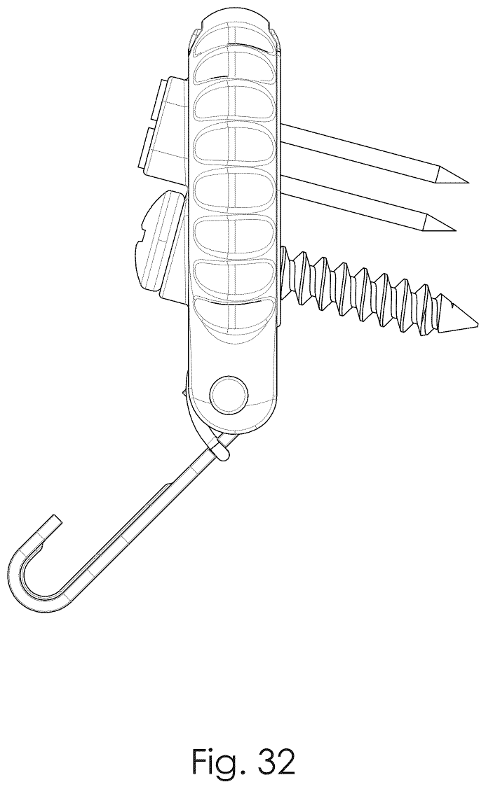

FIG. 33 shows a top plan view of the fourth embodiment of the invention;

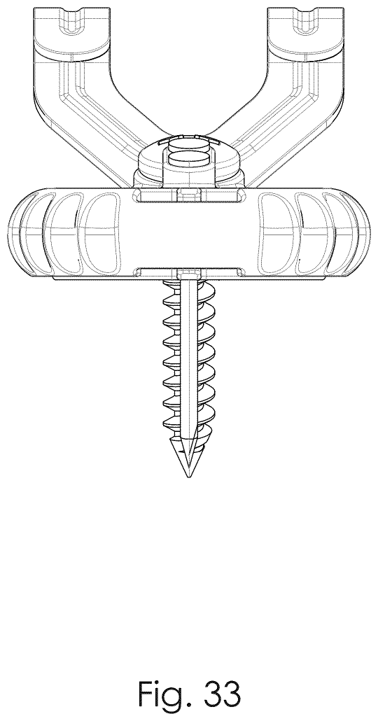

FIG. 34 shows a bottom plan view of the fourth embodiment of the invention;

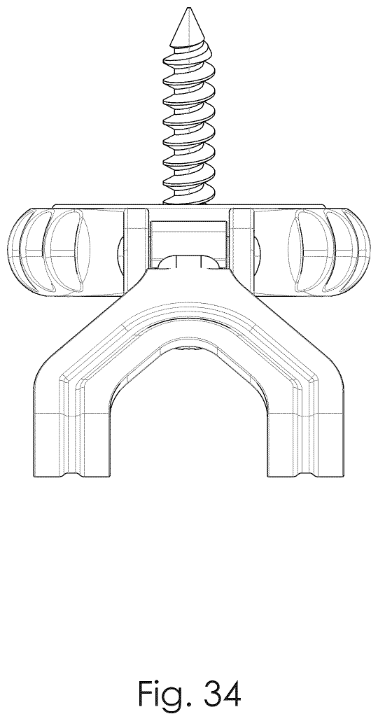

FIG. 35 shows a perspective view of the fourth embodiment of the invention;

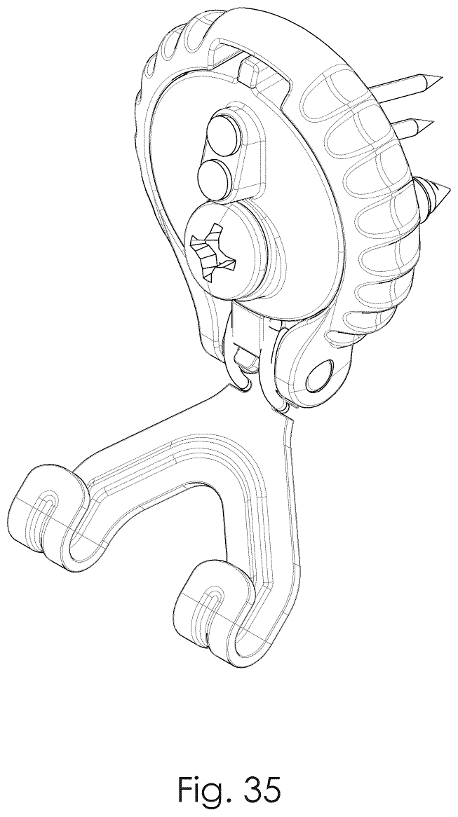

FIG. 36 shows a perspective exploded view of the fourth embodiment of the invention;

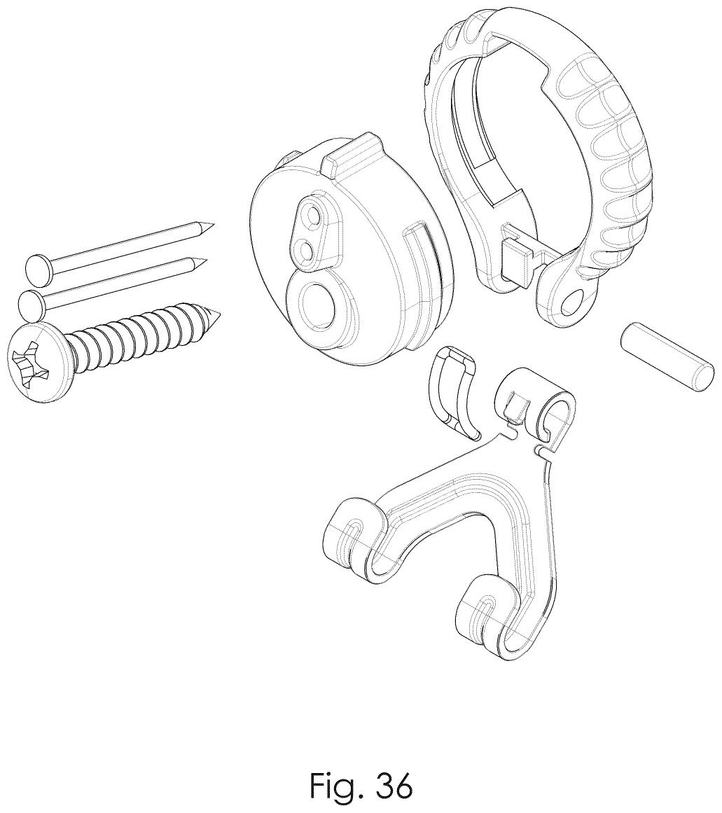

FIG. 37 shows a front elevation view of a fifth embodiment of the invention;

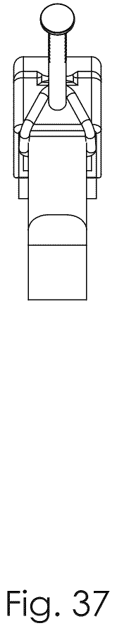

FIG. 38 shows a rear elevation view of the fifth embodiment of the invention;

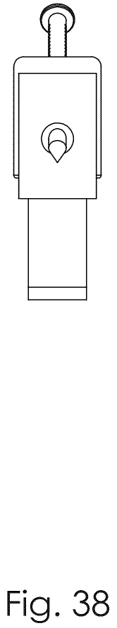

FIG. 39 shows a right elevation view of the fifth embodiment of the invention;

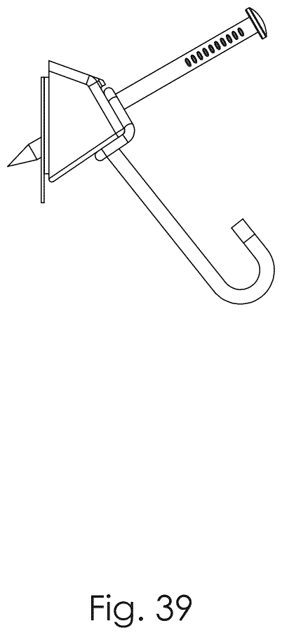

FIG. 40 shows a left elevation view of the fifth embodiment of the invention;

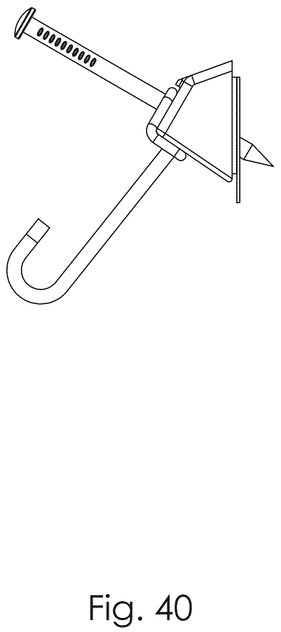

FIG. 41 shows a top plan view of the fifth embodiment of the invention;

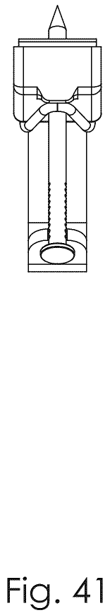

FIG. 42 shows a bottom plan view of the fifth embodiment of the invention;

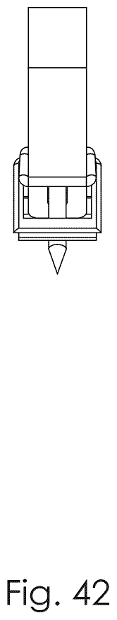

FIG. 43 shows a perspective view of the fifth embodiment of the invention; and

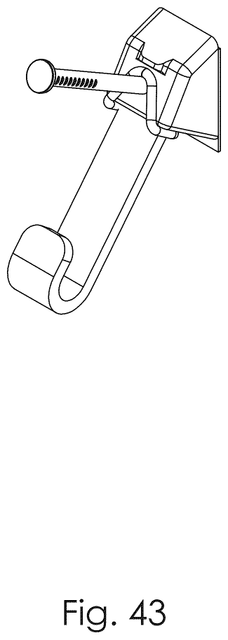

FIG. 44 shows a perspective exploded view of the fifth embodiment of the invention.

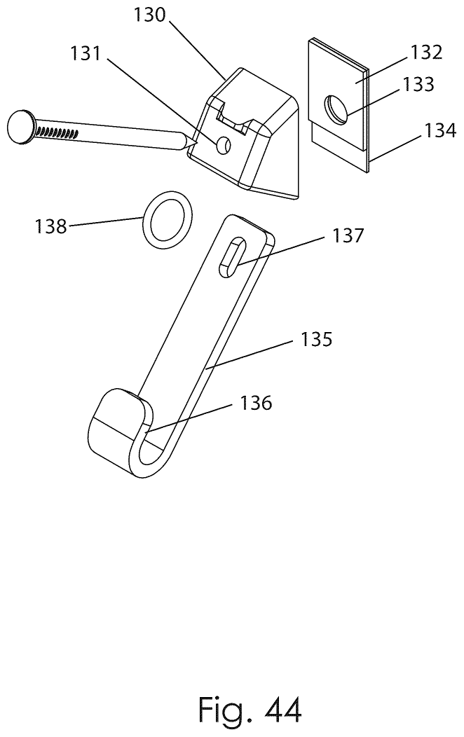

### REFERENCE NUMERALS FOR DRAWINGS

101 wall hanger
102 base portion
103 first cutout
104 lateral arm
105 hanger rod channel
106 first longitudinal axis
107 hanger rod
108 first tongue
109 hanger portion
110 hanger rod hook
111 hanger hook
112 second tongue
113 elastic band
114 base portion channel for receiving fasteners for fastening the base portion to a wall
115 nail
116 y-shaped hanger portion
117 base portion plane of symmetry
118 base portion (equilateral triangle with a truncated apex)
119 base portion (circular)
120 removable clamp
121 clamp arm
122 key
123 key seat
124 screw
130 base portion
131 base portion channel
132 back plate
133 back plate hole
134 back plate tab
135 hanger portion
136 hook
137 elongate slot
138 elastic band

### DESCRIPTION

### Definitions

A wall is any type of generally vertical supporting surface.

As shown in the figures, the preferred embodiments and best mode of using the present invention comprise a wall hanger 101, comprising:
a base portion 102 adapted for mounting to a wall, comprising: a first cutout 103 in a bottom of the base portion 102, the first cutout 103 creating a fork of two lateral arms 104, 104 monolithically extending from the base portion 102; a hanger rod channel 105 for receiving a hanger rod 107, the hanger rod channel 105 having a first longitudinal axis 106 that passes through the first cutout 103 and through each of the two lateral arms 104, 104, the hanger rod channel 105 for receiving the hanger rod 107 such that the first longitudinal axis 106 is coextensive with the hanger rod 107; the base portion 102 further comprising a first tongue 108 suspended in the first cutout between the two lateral arms 104, and at least one base portion channel 114 for receiving a means for fastening the base portion 102 to a wall;
a hanger portion 109 pivotably mountable on the hanger rod 107 in the base portion 102, comprising: a hanger portion proximal end and a hanger portion distal end, the hanger portion proximal end comprising a hanger rod hook 110 for mounting on the hanger rod 107; the hanger portion distal end comprising at least one upwardly opening hanger hook 111 adapted for receiving an article for hanging; and a second tongue 112 monolithically extending from the hanger rod hook;
the hanger rod 107 for supporting the hanger rod hook 110; and
an elastic band 113 for looping around the first tongue 108 and the second tongue 112, the elastic band 113 for holding the hanger portion 109 in an upwardly pivoted position and the tongues 108, 112 for receiving the elastic band and for limiting a hanger portion 109 upwards pivot.

The tongues 108, 112 limit the upward pivot of the hanger portion 109 to forty-five degrees from the vertical.

The means for fastening the base portion 102 to the wall comprises a nail 115.

If a user desires a self-leveling hanger, then the hanger portion distal end comprises two upwardly opening hanger hooks 116, 116 such that the hanger portion is y-shaped 116.

A longitudinal axis of the at least one channel for receiving a means for fastening passes along the base portion plane of symmetry 117.

The first tongue 108 comprises at least one hook to secure the elastic band 113.

A front elevation view of the base portion 118 comprises a shape of an equilateral triangle with a truncated apex.

If a user desires a self-leveling hanger, then another option is where a front elevation view of the base portion 119 comprises a shape of a circle, a peripheral edge of the base portion comprising a removable clamp 120 having two clamp arms 121, 121, and wherein the hanger rod channel 105 passes through the two clamp arms 121, 121.

In such cases, an interior surface of the removable clamp has at least one key 122 and an exterior edge of the base portion has at least one corresponding key seat 123, such that together they form a keyed connection.

A hanger capable of holding more weight can be produced by adding three fastener holes: two for nails and a third for a screw.

The embodiments of the invention further comprise a wall hanger, comprising:
a base portion 130 adapted to mounting to a wall, comprising a base portion channel 131 for receiving a nail for fastening the base portion to a wall, and an open wall-facing section; the nail; a back plate 132 for snap fitting into the base portion 130 open wall-facing section, the back plate 132 comprising a back plate hole 133c for receiving and securing the nail, the back plate 132 further comprising a back plate tab 134 monolithically extending from a back plate 132 bottom, the back plate tab 134 for a user to hold the wall hanger in position for fastening to the wall; a hanger portion 135 pivotably mountable on the nail in the base portion, the hanger portion 135 generally forming a shape of a J, a hanger portion 135 distal end comprising an outwardly facing first hook portion for receiving an article for hanging, a hanger portion 135 proximal end comprising an elongate slot 137 for pivotably hanging on the nail; and the elastic band 138, for looping around the hanger portion 135 and around the nail, thereby biasing the hanger portion 135 to an upwardly pivoted position.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

I claim:

1. A wall hanger, comprising:
a base portion adapted to mounting to a wall, comprising a hanger rod channel and a hanger rod removably positionable therein, and a first tongue monolithically extending therefrom;
a hanger portion pivotably mountable on the hanger rod in the base portion, the hanger portion generally forming a shape of a C, a hanger portion distal end comprising an outwardly facing first hook portion for receiving an article for hanging, a hanger portion proximal end comprising a second hook portion for hanging on the hanger rod, the second hook portion comprising a second tongue monolithically extending therefrom, the hanger portion further comprising a hanger portion body with a pair of lateral slots for receiving an elastic band; and
the elastic band, for looping through the hanger portion pair of lateral slots and around the base portion first tongue, thereby biasing the hanger portion to an upwardly pivoted position;
wherein the first tongue limits an upward pivot of the hanger portion into the upwardly pivoted position by acting as a stop to an upward motion of the second tongue.

2. The wall hanger of claim 1, further comprising a first cutout in a bottom of the base portion, the first cutout creating a fork of two lateral arms monolithically extending from the base portion; the hanger rod channel having a longitudinal axis that passes through the first cutout and through each of the two lateral arms; wherein the first tongue extends into the first cutout between the two lateral arms.

3. The wall hanger of claim 1, further comprising at least one channel in the base portion for receiving a means for fastening the base portion to a wall.

4. The wall hanger of claim 3, wherein the means for fastening the base portion to a wall comprises a nail.

5. The wall hanger of claim 3, wherein the means for fastening the base portion to the wall comprises a screw.

6. The wall hanger of claim 1, wherein the first hook portion comprises a single hook.

7. The wall hanger of claim 1, wherein the first hook portion comprises two hooks, such that the hanger portion is y-shaped.

8. The wall hanger of claim 3, wherein a longitudinal axis of the at least one channel for receiving a means for fastening passes along a base portion plane of symmetry.

9. The wall hanger of claim 1, wherein the first tongue comprises at least one hook for securing the elastic band.

10. The wall hanger of claim 1, wherein a front elevation view of the base portion comprises a shape of an equilateral triangle with a truncated apex.

11. The wall hanger of claim 1, wherein a front elevation view of the base portion comprises a shape of a circle, a peripheral edge of the base portion comprising a removable clamp having two clamp arms, and wherein the hanger rod channel passes through the two clamp arms.

12. The wall hanger of claim 11, wherein an interior surface of the removable clamp has at least one key and an exterior edge of the base portion has at least one corresponding key seat, such that together they form a keyed connection.

13. The wall hanger of claim 1, a terminal end of the second hook comprising a fork of two lateral arms monolithically extending therefrom with the second tongue monolithically extending upwards therebetween.

14. A wall hanger, comprising:
a base portion adapted to mounting to a wall, comprising a base portion channel for receiving a nail for fastening the base portion to a wall, and an open wall-facing section;
the nail;
a back plate for snap fitting into the base portion open wall-facing section, the back plate comprising a back plate hole for receiving and securing the nail, the back plate further comprising a back plate tab monolithically extending from a back plate bottom, the back plate tab for a user to hold the wall hanger in position for fastening to the wall;
a hanger portion pivotably mountable on the nail in the base portion, the hanger portion generally forming a shape of a J, a hanger portion distal end comprising an outwardly facing first hook portion for receiving an article for hanging, a hanger portion proximal end comprising an elongate slot for pivotably hanging on the nail; and
the elastic band, for looping around the hanger portion and around the nail, thereby biasing the hanger portion to an upwardly pivoted position.
